(19) United States
(12) Patent Application Publication
(10) Pub. No.: US 2015/0105900 A1
(43) Pub. Date: Apr. 16, 2015

(54) NUMERICAL CONTROLLER PROVIDED WITH OPERATION SETTING SCREEN

(71) Applicant: FANUC CORPORATION, Minamitsuru-gun (JP)

(72) Inventor: Susumu MAKI, Minamitsuru-gun (JP)

(21) Appl. No.: 14/508,130

(22) Filed: Oct. 7, 2014

(30) Foreign Application Priority Data
Oct. 15, 2013 (JP) 2013-214443

(51) Int. Cl. G05B 19/4097

(52) U.S. Cl. CPC G05B 19/4097; G05B 2219/49372
USPC 700/183

(57) ABSTRACT

A numerical controller for controlling a machine tool is provided with a screen for operation check such that an upper limit value of the speed, on/off functions such as machine lock, enabling or disenabling of M-, S-, and T-codes, etc., can be set in a plurality of patterns, depending on check contents (or levels) on the screen.

### BACKGROUND OF THE INVENTION

1. Field of the Invention

The present invention relates to a numerical controller provided with an operation setting screen.

2. Description of the Related Art

In performing machining by means of a machine tool, it is necessary to check to see if a machining program created by a programmer is not wrong, if the settings and offsets of jigs and tools are correct, etc. The machine tool is provided with a large number of operation support functions for the efficiency and safety of these checks. The operation support functions include various function buttons and selector switches, such as override switches for setting and adjusting the machining speed and microswitches for limiting the axial movement of each axis or all axes, and on/off buttons (e.g., for a coolant, spindle rotation, etc.) corresponding to various M-, S-, and T-codes (auxiliary functions). Checking operation is performed with the various switches and buttons turned on and off depending on the check contents.

In the case of a system in which the machine tool and a robot or the like operate in conjunction with each other, moreover, the contents of operation check at the time of setup are divergent. The machine tool and the robot may independently perform their respective operation checks. For example, the machine tool may check the operation of the machining program, while the robot may give other instructions than that for workpiece replacement. Alternatively, the machine tool and the robot may be linked with each other for operation check. For example, a series of operations may be performed such that the robot replaces a workpiece on receipt of a request for service after machining by the machine tool.

If only the workpiece replacement by the robot is expected to be performed in the case where the machine tool and the robot are linked together for operation check, the machine tool need not actually machine the workpiece. If a program separate from that for actual machining is prepared or the machining program is used in this case, therefore, machine lock is enabled so that the axes are made immovable or dry run is enabled so that the machining program ends early.

Japanese Patent Application Laid-Open No. 2006-4275 discloses a numerical controller in which a program is checked with movable axes of a machine to be controlled kept immovable. In this numerical controller, the program is analyzed to calculate the amounts of movement of the movable axes, and machine coordinate values are updated by the calculated movement amounts. A movable region or stroke limit is checked based on the updated coordinate values.

Japanese Patent Application Laid-Open No. 2007-226383 discloses a numerical controller which determines whether a program in which a specific auxiliary function registered in advance is commanded is a macro-program (or a program called up from a macro-program) or not. Whether or not to execute the auxiliary function is determined based on the result of this determination.

Japanese Patent Application Laid-Open No. 8-71853 discloses an electric discharge machining apparatus configured to execute an auxiliary function, such as working fluid control, based on a program. In a check mode in which the program is checked with the electric discharge machining apparatus in actual operation, coordinates are shifted by a preset amount to avoid a collision between a workpiece and an electrode.

Japanese Patent Application Laid-Open No. 2010-277425 discloses a robot controller that is connected with a machine tool controller by a network cable. Information on a machine tool acquired from the machine tool controller through the network cable is displayed on a display unit on a teaching pendant attached to the robot controller.

In order to efficiently check the operation, various settings or the contents of a machining program must be changed depending on the check content (or level), thus requiring complicated work, such as setting, change, etc. Since contents to be checked vary depending on the contents of the machining program or the user, moreover, it is difficult to automatically determine various on/off switching. Preferably, the operations of the machine tool and the robot should be changed depending on the situation while satisfying both of safety and operating efficiency. Currently, however, there is no machine tool provided with such a mechanism.

### SUMMARY OF THE INVENTION

Accordingly, the object of the present invention is to provide a numerical controller provided with an operation setting screen, capable of efficiently and safely performing operation check work in such a manner that a level corresponding to a check content can be selected depending on setting or selection on the screen or set signal states.

A numerical controller according to the present invention serves to control a machine tool having a plurality of movable axes and comprises: an operation pattern storage section configured to previously store a plurality of sets of set values, including settings of overrides of the respective rapid feed rates of the movable axes of the machine tool, setting of an override of a cutting feed rate, and setting of an override of a spindle speed, settings for enabling or disenabling movements of the movable axes, and settings for enabling or disenabling an M-function, an S-function and a T-function; and an operation pattern selection section configured to select one set of the set values, as an operation pattern, from among the plurality of sets of set values previously stored in the operation pattern storage section, in response to an input signal or signals from the machine tool and/or an external device connected to the machine tool. The machine tool is configured to be controlled based on the operation pattern selected by the operation pattern selection section.

The input signal from the machine tool may be an interlocking signal of the machine tool, and the input signal from the external device connected to the machine tool may be an operation mode signal of the external device.

The operation pattern selection section may be configured to select the operation pattern according to an input signal from a safety fence installed around the machine tool and the external device.

According to the present invention, there can be provided a numerical controller provided with an operation setting screen, capable of efficiently and safely performing operation check work in such a manner that a level corresponding to a check content can be selected depending on setting or selection on the screen or set signal states.

### BRIEF DESCRIPTION OF THE DRAWINGS

The above and other objects and features of the present invention will be obvious from the ensuing description of embodiments with reference to the accompanying drawings, in which:

FIG. 1 is a diagram illustrating a work system comprising a machine tool and a robot configured to perform operations in conjunction with the machine tool;

FIG. 2 is a schematic block diagram of a numerical controller for controlling the machine tool of FIG. 1;

FIG. 3 is a diagram illustrating an example of selection of an operation check mode on a screen;

FIG. 4 is a diagram illustrating an example of change of contents on the screen by a user;

FIG. 5 is a diagram illustrating an example of selection of the level of operation check based on a combination of set signal states; and

FIG. 6 is a diagram illustrating an example of change of operation settings for the set signal states.

### DETAILED DESCRIPTION OF THE PREFERRED EMBODIMENTS

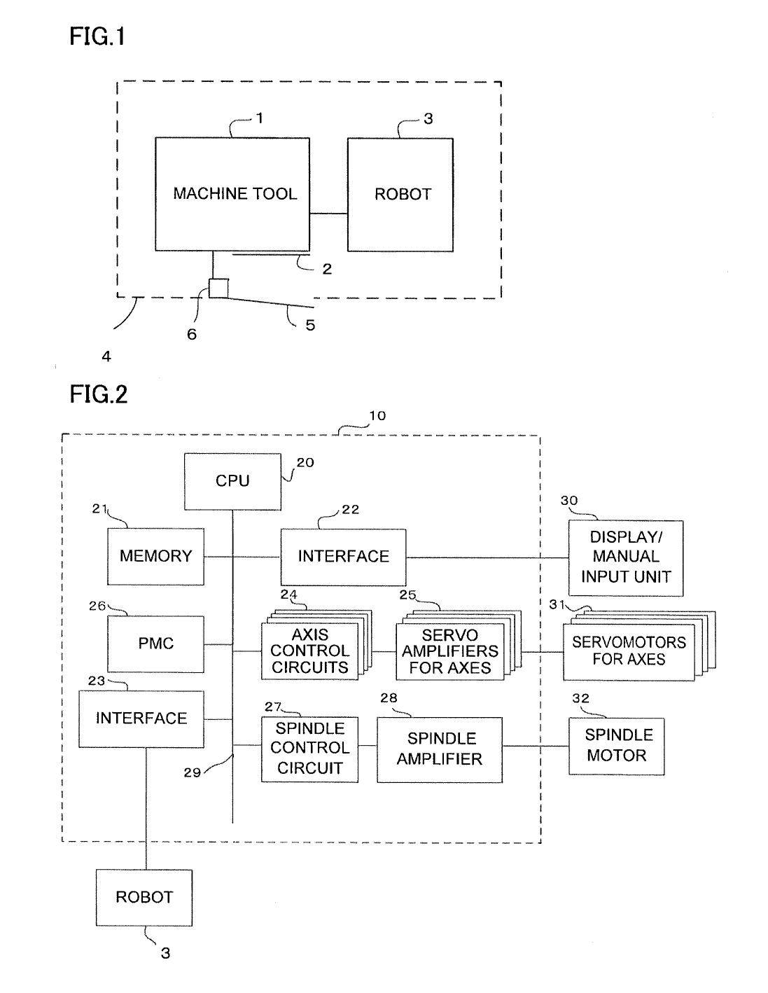

FIG. 1 is a diagram illustrating a work system comprising a machine tool controlled by a numerical controller shown in FIG. 2 and a robot configured to perform operations in conjunction with the machine tool.

A machine tool 1 and a robot 3 are surrounded by a safety fence 4. A case of the machine tool 1 is provided with an open/close door 2 through which a workpiece is carried into and out of the case. Further, the safety fence 4 is provided with a safety-fence door 5 through which an operator can get into and out of an area surrounded by the safety fence 4. The safety-fence door 5 is fitted with a safety-fence door open/close sensor 6 for detecting the open or closed state of the door 5. A detection signal indicative of an open or closed state of the safety-fence door 5 output from the door open/close sensor 6 is input to a numerical controller 10.

FIG. 2 is a schematic block diagram of the numerical controller for controlling the machine tool of FIG. 1.

A CPU 20 is a microprocessor for generally controlling the numerical controller 10. The CPU 20 is connected with a memory 21, first and second interfaces 22 and 23, axis control circuits 24, programmable machine controller (PMC) 26, and spindle control circuit 27 by a bus 29.

The CPU 20 reads a system program from a ROM in the memory 21 through the bus 29 and controls the entire numerical controller 10 according to the system program. The memory 21 comprises the ROM, a RAM, a nonvolatile memory, etc. The ROM stores the system program, etc., while the RAM stores temporary calculation data, display data, and various data input through a display/manual input unit 30. Further, the nonvolatile memory is composed of an SRAM backed up by a battery.

The first interface 22 is connected with the display/manual input unit 30, which comprises a display, such as a liquid crystal display, keyboard, etc. On the other hand, the second interface 23 enables connection to an external device (e.g., robot 3). A robot operation state signal is input to the numerical controller 10 through the second interface 23.

The PMC 26 outputs a signal to an auxiliary device of the machine tool, which is a control object, according to a sequence program stored in the numerical controller 10, thereby controlling the auxiliary device. Further, the PMC 26 receives signals from various switches on the machine tool body (on the door 2 of FIG. 1), processes them as required, and then delivers the signals to the CPU 20. The PMC 26 also receives a detection signal from the door open/close sensor 6 for detecting the open or closed state of the door 5 on the safety fence 4.

The axis control circuits 24 for controlling feed axes, such as X-, Y-, and Z-axes, receive move commands for the feed axes from the CPU 20 and output commands for the feed axes to their corresponding servo amplifiers 25, thereby driving servomotors 31 for the feed axes. Further, the axis control circuits 24 perform position/speed feedback control on receipt of position/speed feedback signals from position/speed sensors incorporated in the servomotors 31. Thus, the rotational speeds of the servomotors are controlled to conform to command speeds.

On receipt of a spindle speed command from the CPU 20, the spindle control circuit 27 outputs a spindle speed signal to a spindle amplifier 28. On receipt of the spindle speed signal from the spindle control circuit 27, the spindle amplifier 28 rotates the spindle motor 32 at a commanded rotational speed (or rotational frequency). Then, the spindle control circuit 27 receives a detection signal (feedback pulses) from a position sensor (not shown) attached to the spindle motor 32, and controls (feedback-controls) the spindle speed so that it conforms to the spindle speed command.

The hardware configuration of the numerical controller according to the present invention is the same as that shown in FIG. 2. Means for displaying an operation setting screen is stored as software in the memory 21 of FIG. 2.

The numerical controller 10 according to the present invention is provided with a screen for operation check such that the upper limit value of the speed, on/off switching such as machine lock, enabling or disenabling of M-, S-, and T-codes, etc., can be set in a plurality of patterns, depending on the check content (or level). The screen for operation check is displayed on the display screen of the display/manual input unit 30.

The various on/off states and the enabling or disenabling of the codes are switched according to set contents by selecting one of the patterns corresponding to the check content. The level of operation restriction should be automatically changed in response to state signals from the machine tool and the robot.

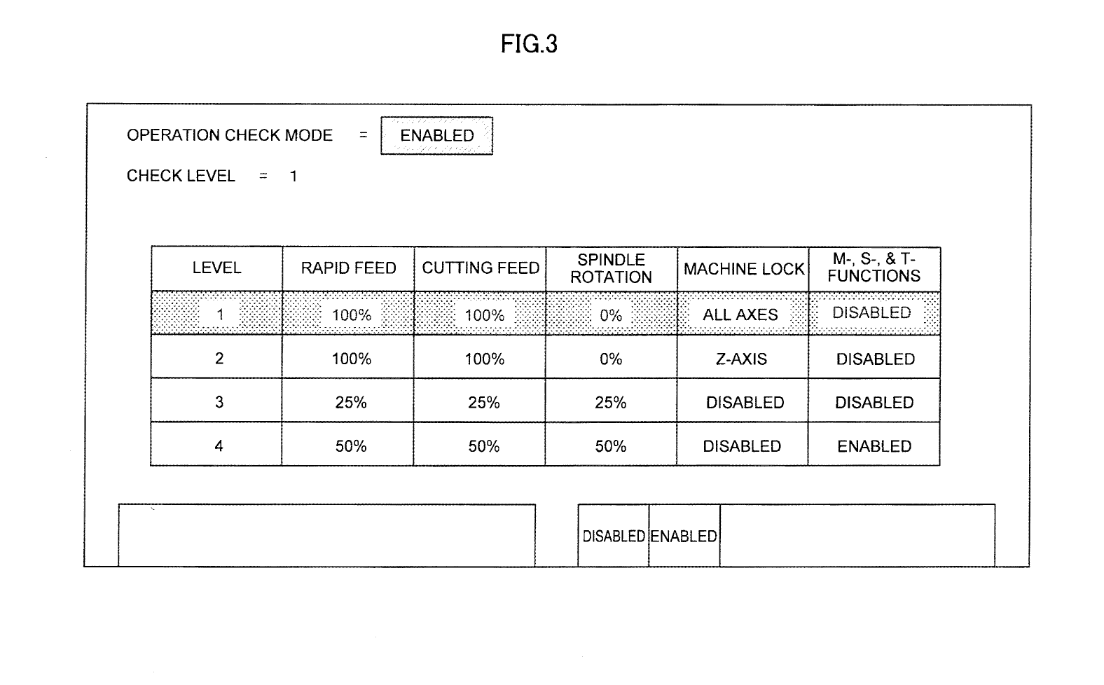

(1) An example of selection of an operation check mode on a screen will be described with reference to FIG. 3.

At Level 1, according to the screen example of FIG. 3, the spindle is not rotated, all the axes are machine-locked, and M-, S-, and T-functions are disabled. Therefore, this level is suitable for the case where a machining program is checked without moving the axes. The M-function is the function of controlling machine operations, such as stopping of the spindle rotation, cutting fluid supply, etc. The S-function is the function of commanding the spindle speed. The T-function is the function of commanding tool indexing.

At Level 2, compared with Level 1, the setting of the machine lock is changed to the Z-axis, and the X- and Y-axes move, though the spindle does not rotate. Therefore, this level is suitable for X- and Y-axis stroke check, drilling, tap position check, etc.

At Level 3, the axis movement speed is limited to 25%, although the machine lock is disabled so that all the axes are allowed to move. Therefore, this level is suitable for the case where the operations of all the axes including the Z-axis are slowly checked.

At Level 4, the M-, S-, and T-functions are enabled and the axis speed is set to 50%. Therefore, this level is suitable for check in a state of operation other than machining and similar to actual machining, such as coolant on/off, operation of a workpiece clamping tool.

In the screen example of FIG. 3, a cursor is in a position corresponding to Level 1. Thus, selected “operation check mode” is “enabled”, and “check level” is “Level 1”. Soft keys “disable”, “enable”, etc., are displayed at the lower part of the screen. The cursor constitutes “operation pattern selection section” of the numerical controller.

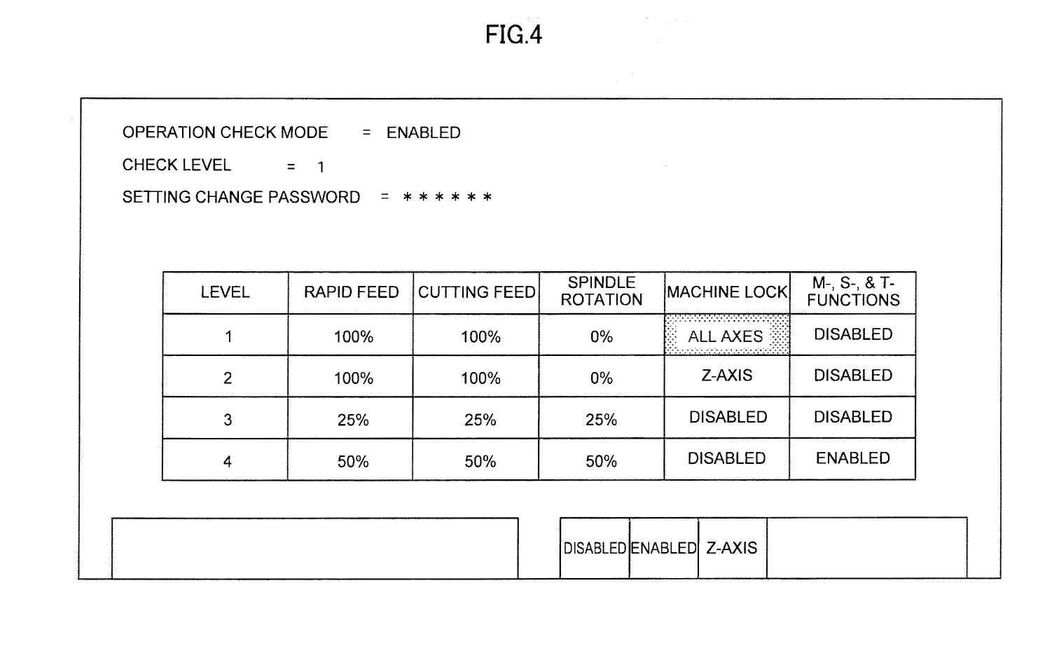

(2) An example of change of contents on the screen by a user will be described with reference to FIG. 4.

The set contents must be changed depending on the contents of the machining program and the user's checking operation. The screen example of FIG. 4 differs from that of FIG. 3 in that only the administrator of the machine is allowed to change the settings and an item for inputting a password is added.

In the screen example of FIG. 4, “operation check mode” is “enabled”, and “1” is selected for “check level”. The cursor is on “all axes” of “machine lock”, which indicates that the settings for all the machine-locked axes are to be changed.

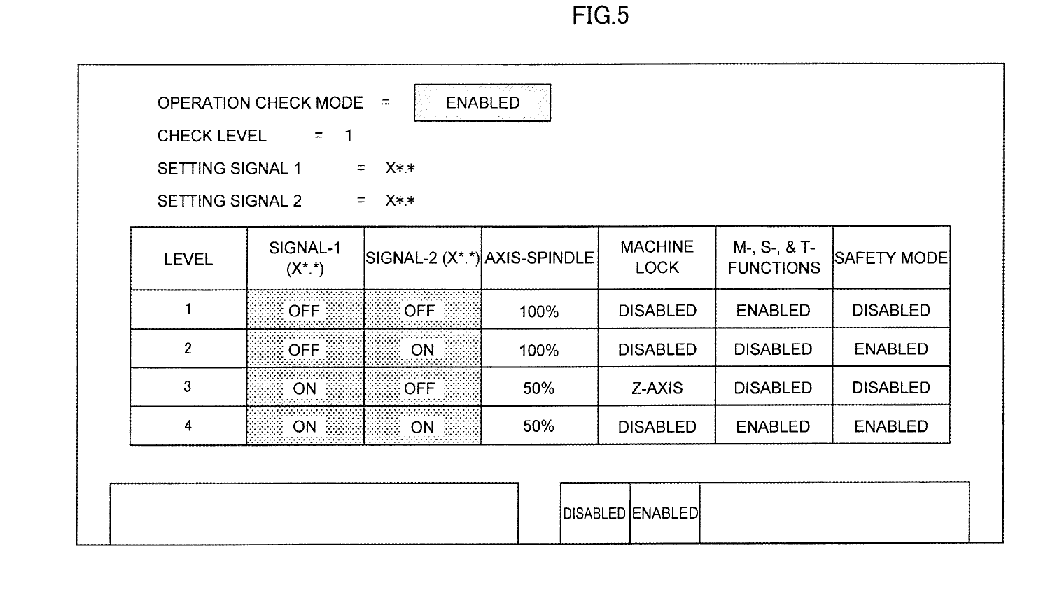

(3) An example of selection of the level of operation check based on a combination of set signal states will be described with reference to FIG. 5.

According to the screen example of FIG. 5, an interlocking signal (Signal-1) of the machine tool and an operation mode signal with the robot used as the external device are used as the state signals. The interlocking signal is a signal for switching the operational linkage between the machine tool and the robot. The operation mode signal is a teaching mode signal (Signal-2) for switching the state of the robot, whether being taught or not. A combination of the interlocking signal (Signal-1) and the teaching mode signal (Signal-2) constitutes “operation pattern selection section” of the numerical controller.

At Level 1, according to the screen example of FIG. 5, both the interlocking signal (Signal-1) and the teaching mode signal (Signal-2) are OFF. At this level, therefore, the robot and the machine tool operate independently of each other, so that a substantially disabled state is established without limitations on their respective operations.

At Level 2, the interlocking signal (Signal-1) is OFF, while the teaching mode signal (Signal-2) is ON. If the door of the machine tool for workpiece replacement is opened at this level, therefore, a safety mode is enabled on the assumption that there is an operator who gives instructions to the robot near the door. When the safety mode is on, the movement speed of the machine tool and the spindle rotation are limited to ensure the operator's safety if the door for workpiece replacement is opened.

At Level 3, the interlocking signal (Signal-1) is

ON, while the teaching mode signal (Signal-2) is OFF. At this level, therefore, the machine tool and the robot are linked together, and the robot is not being taught. Since the operation check is still in process, however, machine lock on the Z-axis is enabled to prohibit actual machining, and the axis speed is limited to 50%.

At Level 4, both the interlocking signal (Signal-1) and the teaching mode signal (Signal-2) are ON. At this level, therefore, the robot is taught as it is linked with the machine. Although the axis speed is limited, all the axes including the Z-axis are allowed to move, and the operations of the coolant and the door for jig/workpiece replacement are normally performed.

Since the robot is used as the external device in the arrangement described above, the teaching mode signal (Signal-2) for switching the state of the robot, as to whether the robot is being taught or not, is used as the operation mode signal. If a workpiece replacement device, such as an autoloader, is used as the external device, however, a mode signal for switching the mode of the workpiece replacement operation, automatically switching mode or manually switching mode, is used as the operation mode signal.

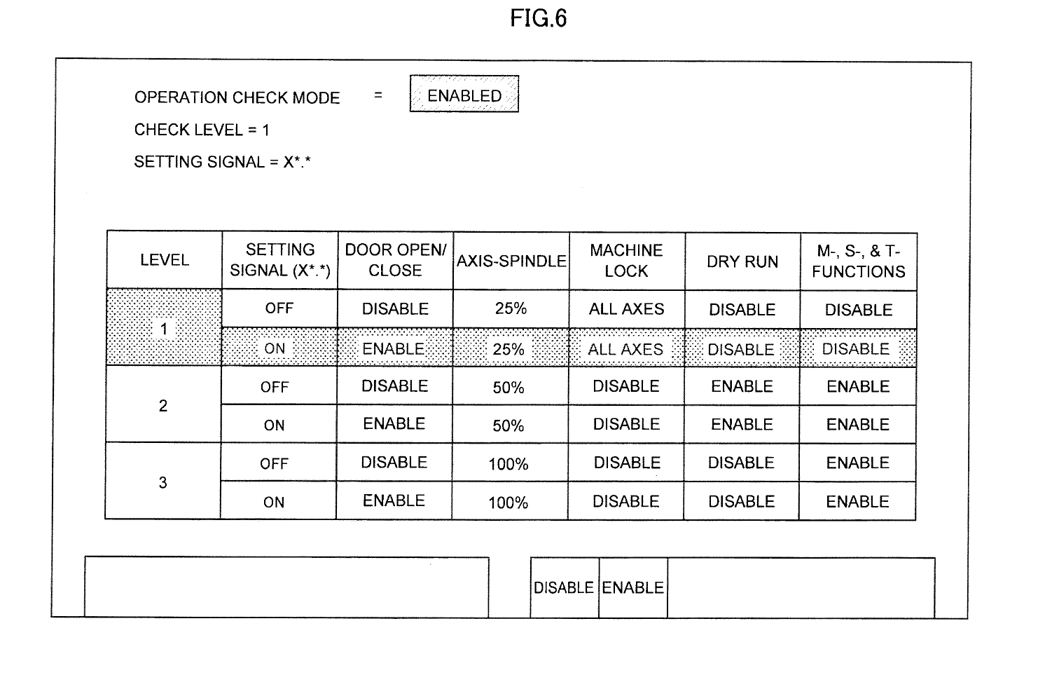

(4) An example of change of operation settings for the set signal states will be described with reference to FIG. 6.

According to the screen example of FIG. 6, a switching signal for the safety fence around the robot is used as a state signal. The signal is ON when the safety fence is open. The level itself is set by the operator. When the safety fence is open (with the signal OFF), the operator is supposed to stand beside the door of the machine tool for workpiece replacement, so that door opening and closing operations are disabled (“door open/close” is “disabled”) for the sake of safety.

1. A numerical controller for controlling a machine tool having a plurality of movable axes, comprising:
an operation pattern storage section configured to previously store a plurality of sets of set values, including settings of overrides of the respective rapid feed rates of the movable axes of the machine tool, setting of an override of a cutting feed rate, and setting of an override of a spindle speed, settings for enabling or disenabling movements of the movable axes, and settings for enabling or disenabling an M-function, an S-function and a T-function; and
an operation pattern selection section configured to select one set of the set values, as an operation pattern, from among the plurality of sets of set values previously stored in the operation pattern storage section, in response to an input signal or signals from the machine tool and/or an external device connected to the machine tool,
wherein the machine tool is configured to be controlled based on the operation pattern selected by the operation pattern selection section.

2. The numerical controller according to claim 1, wherein the input signal from the machine tool is an interlocking signal of the machine tool, and the input signal from the external device connected to the machine tool is an operation mode signal of the external device.

3. The numerical controller according to claim 1, wherein the operation pattern selection section is configured to select the operation pattern according to an input signal from a safety fence installed around the machine tool and the external device.
